(19) United States
(12) Patent Application Publication
(10) Pub. No.: US 2025/0075551 A1
(43) Pub. Date: Mar. 6, 2025

(54) System and Vehicle

(71) Applicant: Vitesco Technologies GmbH, Regensburg (DE)

(72) Inventor: Willibald Reitmeier, Hemau / Hohenschambach (DE)

(73) Assignee: Vitesco Technologies GmbH, Regensburg (DE)

(21) Appl. No.: 18/580,439

(22) PCT Filed: Jul. 7, 2022
(86) PCT No.: PCT/EP2022/068995

§ 371 Date: Jan. 18, 2024

(30) Foreign Application Priority Data
Jul. 21, 2021 (DE) 10 2021 118 812.1

(51) Int. Cl. E05F 15/40

(52) U.S. Cl. CPC E05F 15/40; E05Y 2400/44; E05Y 2900/531

(57) ABSTRACT

Various embodiments of the teachings herein include a system for a vehicle having a vehicle body and a vehicle door held pivotably on the vehicle body. An example system includes: an anti-trap protection device to detect a trapping event occurring between the vehicle door and the vehicle body; and an obstacle identification system to detect a collision event occurring between the vehicle door and an object in surroundings of the vehicle. At least one sensor operates both for detection of the trapping event and for detection of the collision event.

### CROSS-REFERENCE TO RELATED APPLICATIONS

This application is a U.S. National Stage Application of International Application No. PCT/EP2022/068995 filed Jul. 7, 2022, which designates the United States of America, and claims priority to DE Application No. 10 2021 118 812.1 filed Jul. 21, 2021, the contents of which are hereby incorporated by reference in their entirety.

### TECHNICAL FIELD

The present disclosure relates to vehicles. Various embodiments of the teachings herein include a system for a vehicle, including an anti-trap protection device designed to detect a trapping event occurring between the vehicle door and the vehicle body, and an obstacle identification system designed to detect a collision event occurring between the vehicle door and an object within the surroundings of the vehicle.

### BACKGROUND

Anti-trap protection devices and obstacle identification systems are used to prevent people or objects from being trapped or collisions when manually or partially or fully automatically opening or closing a vehicle door or hatch. For example, a closing movement can be aborted or an immediate opening movement, which is in the opposite direction to the closing movement, can be carried out if a trapping event is detected. A warning signal can also be emitted, for example, if opening a vehicle door would possibly lead to a collision with a static or moving object in the surroundings of the vehicle. This is intended to prevent personal injury, damage to objects, or damage to the vehicle itself.

### SUMMARY

The teachings of the present disclosure include improved systems and/or methods for identifying and preventing trapping events and/or collision events. For example, some embodiments include a system for a vehicle, wherein the vehicle (2) has a vehicle body (4) and a vehicle door (6), wherein the vehicle door (6) is held pivotably on the vehicle body (4), wherein the system (8) has: an anti-trap protection device (10) designed to detect a trapping event occurring between the vehicle door (6) and the vehicle body (4), and an obstacle identification system (12) designed to detect a collision event occurring between the vehicle door (6) and an object (14) within the surroundings (U) of the vehicle (2), characterized in that at least one sensor (16) is provided, which is designed both for the detection of the trapping event and for the detection of the collision event.

In some embodiments, a first view of a contour of the vehicle door (6), viewed starting from a mounting point of the sensor (16), is stored in a data memory (22), wherein the first view is assigned to a first door opening angle of the vehicle door (6) relative to the vehicle body (4), a second view of the contour of the door, viewed starting from the mounting point of the sensor, is stored in the data memory, wherein the second view is assigned to a second door opening angle of the door relative to the vehicle body, wherein the first door opening angle is greater than the second door opening angle.

In some embodiments, the sensor (16) is designed to determine the door opening angle and/or an angle encoder (24) is provided to determine the door opening angle.

In some embodiments, the sensor (16) is located in the region of an end (28) of the vehicle door (6) facing away from an attachment point (28) of the vehicle door (6) and/or the vehicle door (6) does not cover the sensor (16) when the vehicle door (6) is closed and/or the sensor (16) is fitted in an upper third of the vehicle, in particular above the vehicle door (6), when viewed along a height of the vehicle (2) and/or the sensor (16) is fitted in a middle or lower third of the vehicle when viewed along a height of the vehicle (2).

In some embodiments, a door drive (30) is assigned to the vehicle door (6), wherein the door drive is designed for partially or fully automatic pivoting of the vehicle door (6).

In some embodiments, the sensor (16) is designed for one-dimensional, two-dimensional or three-dimensional identification of the surroundings and/or for measuring distances and/or angles and/or the sensor (16) is a non-contact operating sensor and operates, in particular, according to one or more of the following measuring principles: ultrasound, radar, optical; and/or the sensor (16) can be folded out and/or extended and/or pivoted and/or the sensor is designed to determine the position of a trapping event and/or a collision event.

In some embodiments, at least one further sensor (32) is assigned to the vehicle door (6), wherein the further sensor (32) is, in particular, a contact operating sensor (32) or a near-field operating sensor, wherein the near-field operating sensor is, in particular, a capacitively or resistively operating sensor.

In some embodiments, a control device is assigned to the anti-trap protection device and the obstacle identification system, wherein the control device has one or more of the following functions: door assistance, whereby one or more of the following functions are triggered in the event of detection of a trapping event and/or a collision event: emitting a warning signal; limiting an opening or closing path of the door; limiting a closing force of the door; initiating countermeasures; blocking or releasing the door in a door angle position, a door opening position or a door closing position; teaching mode for teaching a new door geometry; parking assistance, whereby the sensor is designed to ascertain parking spaces; driving assistance, whereby the sensor is designed to ascertain moving and/or static objects in the surroundings of the vehicle, such as, for example, a turn assist system, a parking garage assist system or similar; access assistance, whereby the sensor is used to enable and/or monitor the door for identification of persons, gesture recognition and motion detection as an alarm function; recognition of a gesture or hands-on function; and warning in case of unsafe terrain, such as holes, debris or similar.

As another example, some embodiments include a vehicle, wherein the vehicle (2) has a vehicle body (4) and a vehicle door (6), wherein the vehicle door is held pivotably on the vehicle body, having a system as described herein.

In some embodiments, at least two doors (6) of the vehicle (2) are monitored using the system (8), wherein at least one sensor (16) is assigned to each one of the at least two doors (6).

### BRIEF DESCRIPTION OF THE DRAWINGS

The teachings herein are described in greater detail below with reference to a drawing illustrating exemplary embodiments. In the figures, in each case highly schematically:

FIG. 1 shows a perspective view of a vehicle incorporating teachings of the present disclosure; and

FIG. 2 shows another perspective view of the vehicle from FIG. 1.

### DETAILED DESCRIPTION

Some examples of the teachings herein include a system for a vehicle, wherein the vehicle has a vehicle body and a vehicle door, wherein the vehicle door is held pivotably on the vehicle body, wherein the system has: an anti-trap protection device designed to detect a trapping event occurring between the vehicle door and the vehicle body, and an obstacle identification system designed to detect a collision event occurring between the vehicle door and an object within the surroundings of the vehicle. The system is distinguished in that at least one sensor is provided, which is designed both for the detection of the trapping event and for the detection of the collision event. The system therefore makes it possible to use a single sensor to monitor both a trapping event and a collision event involving a vehicle door to be monitored by the system. This enables a compact and cost-effective implementation of both monitoring of the surroundings of a vehicle door and anti-trap protection.

The system may include additional sensors that, in addition to the sensor, enable additional monitoring of trapping or collision events. However, the system has the at least one sensor designed and suitable for both the detection of a trapping event and for the detection of a collision event. When the detection of a trapping event occurring between the vehicle door and the vehicle body is referred to in the present case, the term detection includes both the identification of an actually occurring trapping event, that is to say the presence of an object trapped between the vehicle door and the vehicle body, as well as the identification of a possible impending trapping event in the future in order to prevent these with appropriate countermeasures or warning functions.

This also applies to the detection of a collision event occurring between the vehicle door and an object in the surroundings of the vehicle. The detection of the collision event therefore involves both identifying an actually occurring collision and identifying a collision that may occur in the future in order to be able to initiate countermeasures or generate warning signals to avoid the impending collision.

The terms door and vehicle door are used synonymously here.

In some embodiments, a first view of a contour of the door, viewed starting from a mounting point of the sensor, may be stored in a data memory, wherein the first view is assigned to a first door opening angle of the door relative to the vehicle body, and for a second view of the contour of the door, viewed starting from the mounting point of the sensor, to be stored in the data memory, wherein the second view is assigned to a second door opening angle of the door relative to the vehicle body, wherein the first door opening angle is greater than the second door opening angle.

In some embodiments, a plurality of views of the contour of the door, viewed starting from the mounting point of the sensor, may be assigned to a plurality of different door opening angles and stored in the data memory, such that the sensor can determine the door opening angle of the door based on the contour of the door. In particular, therefore, the opening angle of the door can be determined by processing and assigning a door contour detected by the sensor to a door contour stored in the data memory.

Furthermore, by storing a respective view of the door contour and the associated door opening angle, it is known what space the vehicle door occupies for a certain door opening angle. In this way, it is possible to predetermine the door opening angle, if any, at which a collision event or a trapping event could occur in the future. In some embodiments, the door opening angle can be achieved by measuring the distance to a reference point on the door by means of the sensor, whereby each measured distance is assigned a door opening angle.

In some embodiments, the sensor may be designed to determine the door opening angle. In some embodiments, provision may be made for an angle encoder to be provided for determining the door opening angle. Accordingly, the angle encoder may be used for adjusting a door opening angle determined by means of the sensor or may be provided independently as a measuring device for determining the door opening angle of the vehicle door.

The sensor may be located in the region of an end of the vehicle door facing away from an attachment point of the vehicle door. In particular, in the event that the sensor is provided for determining the door opening angle, this position allows a particularly good distinction between the contour of the vehicle door and different door opening angles, since, from this viewpoint of the sensor at a distance from the attachment point, a particularly large change in the contour to be detected with the changing angular position of the vehicle door takes place.

In some embodiments, the vehicle door may not cover the sensor when the vehicle door is closed. This sensor enables both reliable obstacle identification and reliable anti-trap protection in any position of the vehicle door.

The sensor may be fitted in an upper third of the vehicle, in particular above the vehicle door, when viewed along a height of the vehicle. If a height of the vehicle is mentioned here, it is measured parallel to the vertical. The arrangement of the sensor in the upper third of the vehicle, especially in the upper quarter of the vehicle, has the advantage that the sensor covers a larger viewing area compared to a lower arrangement.

The sensor may be fitted in a middle or lower third of the vehicle when viewed along a height of the vehicle. Said sensor may be a radar or ultrasonic sensor, in particular.

A door drive may be assigned to the vehicle door, wherein the door drive is set up for partially automatic or fully automatic pivoting of the vehicle door. The door drive can therefore assist in or can completely automatically carry out the opening and/or closing the vehicle door. In particular, the door drive may have a motor for partially automatic or fully automatic pivoting of the vehicle door. In particular, the motor can be assigned mechanical components for the translation or reduction of the motor movement, such as a spindle operation or similar. The motor may also be embodied as a direct drive.

The sensor may be designed for one-dimensional, two-dimensional or three-dimensional identification of the surroundings and/or for measuring distances and/or angles. In particular, the sensor is designed both for measuring distances and for measuring angles in order to be able to clearly determine a position of an object relative to the vehicle and/or to the sensor.

The sensor may be a non-contact operating sensor and operate, in particular, according to one or more of the following measuring principles: ultrasound, radar, optical.

The sensor may be able to be folded out and/or extended and/or pivoted in order to achieve an improved or optimized field of view in which the position of the sensor is adjusted, depending on the state of the vehicle or the position of the vehicle door.

The sensor may be designed to determine the position of a trapping event and/or a collision event. The position of a trapping event and/or a collision event or a possible impending trapping event and/or collision event may have a significant impact on the expected damage or the hazard posed by the trapping event and/or collision event. Accordingly, the detected position of the trapping event and/or the collision event may have an influence on which warnings and/or countermeasures have to be issued or initiated. Position determination may be used to open or close the door until just before the occurrence of the trapping event or collision event, in particular automatically.

In some embodiments, at least one further sensor may be assigned to the vehicle door, wherein the further sensor is, in particular, a contact operating sensor or a near-field operating sensor. The near-field operating sensor may be, in particular, a capacitively or resistively operating sensor. In particular, the sensor may be used to create redundancies in particularly critical areas. For example, the further sensor may be used for the additional detection of a trapping event and, for example, detection of a local compression of a sealing rubber of the vehicle door.

A control device may be assigned to the anti-trap protection device and the obstacle identification system, wherein the control device has one or more of the following functions:
a function that may be referred to as door assistance, whereby one or more of the functions listed below are triggered in the event of detection of a trapping event and/or a collision event: emitting a warning signal; limiting an opening path or closing path of the door; limiting a closing force of the door; initiating countermeasures; blocking or releasing the door in a door angle position, a door opening position or a door closing position. In particular, in the event that a door drive is assigned to the vehicle door, the control device may actively engage in the positioning or the released actuator or pivot paths of the door using the door assistance function in order to prevent a collision event or a trapping event before it occurs, or to stop it after it is identified.
a function that may be referred to as teach mode and is used to teach a new door geometry. In this mode, the vehicle door is moved manually or automatically into different positions of the door opening angle in order to detect the view of the contour of the vehicle door associated with a door opening angle. In this way, the system may be adapted to or taught a geometry or a contour of an unknown vehicle door. This allows the system to be easily used with or adapted to a wide range of different vehicle models.
a function that may be referred to as parking assistance, and enables, in particular, the finding of free parking spaces and the active or fully automatic parking aid, whereby the sensor of the parking assistance function in particular provides data on the position of static or moving objects in the surroundings.
a function that may be referred to as driving assistance and is used, for example, for partially automatic or fully automatic adherence to a predetermined travel path, whereby the sensor of the driving assistance function in particular provides data on the position of static or moving objects in the surroundings, such as, for example, a turn assist system, a parking garage assist system, a blind spot assist system or similar.
a function that may be referred to as access assistance and is used, for example, for the release of access to the passenger compartment or for monitoring the passenger compartment, whereby the sensor in particular provides data for the release and/or monitoring of the vehicle door for personal identification and/or for gesture recognition or motion detection and for supporting an alarm function.
a function that serves to recognize a gesture or is a hands-on function, whereby, for example, a force pulse measured in the region of the door, together with a position signal of the sensor, identifies an opening request of an operator, wherein the force pulse can be assigned to the operator on the basis of the position signal of the sensor and can be distinguished, for example, from a gust of wind or similar. It is thus possible to identify, in particular, whether a hand of the operator was/is arranged on or near the door and the position of the hand can be correlated with a measured force pulse. The function may also include a supporting opening and/or closing of the door, whereby opening and/or closing of the door is carried out autonomously as a result of a pulse introduced into the door by the operator.
a function for warning in case of unsafe terrain, such as holes, debris or similar. If, for example, a deep hole, a chasm or severe unevennesses are identified next to the door, a warning signal, for example, may be emitted and/or the opening of the door may be blocked, even though opening the door in this case would not lead to a collision.

In addition to the basic function of the sensor of the system to enable an anti-trap protection device and an obstacle identification system, the data provided by the sensor may therefore be combined in a variety of ways with other assistance systems of a vehicle. For example, the sensor may be used to detect curbs, holes or bollards in the surroundings of the vehicle or warn of collisions, or to identify static or moving objects in the surroundings of the vehicle as a whole.

Some examples include a vehicle, wherein the vehicle has a vehicle body and a vehicle door, wherein the vehicle door is held pivotably on the vehicle body, having a system as described herein. At least two doors of the vehicle may be monitored using the system, wherein at least one sensor is assigned to each one of the at least two doors.

When a door or a vehicle door of the vehicle is referred to in the present case, it may be, for example, a driver door, a passenger door or a rear door of the vehicle, which allow access to the passenger compartment of the vehicle. As an alternative or in addition, however, a vehicle door or a door also applies to any hatch of the vehicle allowing access to a storage compartment or engine compartment or to any other volume enclosed by a hatch, such as a hood, tailgate or trunk hatch, as well as hatches that allow access to gas pump nozzles or charging sockets of a vehicle, such as a gas cap, a charging flap or similar.

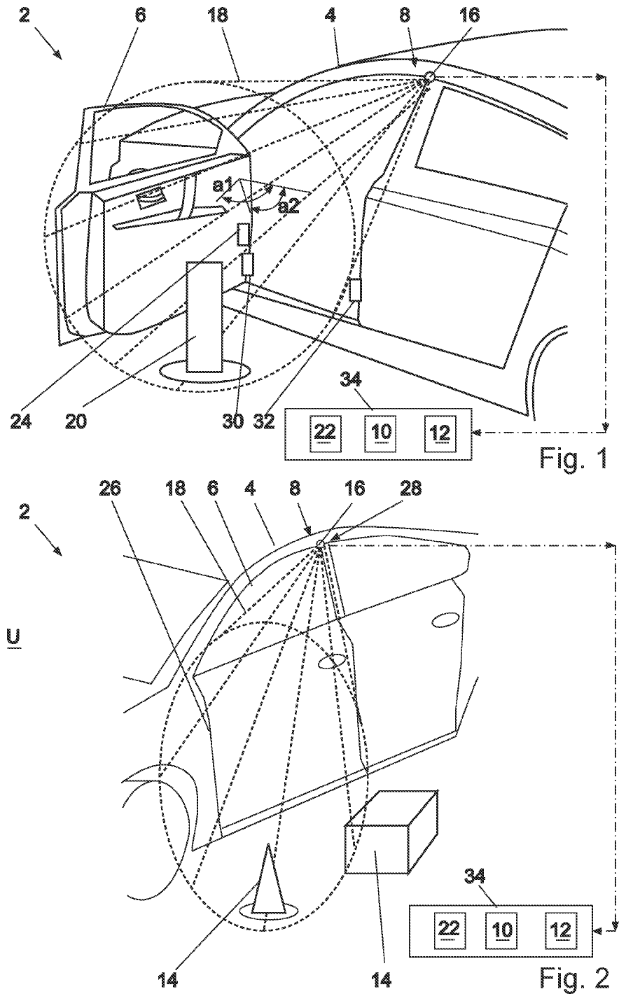

FIG. 1 shows a perspective view of a vehicle 2 incorporating teachings of the present disclosure. Only a section of the vehicle 2 is shown, with the rear section of the vehicle 2 hidden. The vehicle 2 has a vehicle body 4 and a vehicle door 6. The vehicle door 6 is held pivotably on the vehicle body 4.

The vehicle 2 has a system 8 with an anti-trap protection device 10 designed to detect a trapping event occurring between the vehicle door 6 and the vehicle body 4. The system 8 has an obstacle identification system 12 designed to detect a collision event occurring between the vehicle door 6 and an object 14 within the surroundings U of the vehicle 2.

The system 8 has a sensor 16 designed both for the detection of the trapping event and for the detection of the collision event.

In the present case, a viewing area 18 or field of view 18 of the sensor 16 is indicated by the dashed lines as a cone 18. The sensor 16 is therefore able to detect an object 20 arranged between the vehicle door 6 and the body 4.

FIG. 2 shows the field of view 18 of the sensor 16 when the vehicle door 6 is closed. The sensor 16 is therefore able to detect objects 14 arranged in the surroundings U of the vehicle 2. The sensor 16 is designed to detect a distance and an angle of the objects 14, 20 relative to the sensor 16 and/or relative to another reference point of the vehicle 2.

In the present case, a first view of a contour of the door 6, viewed starting from a mounting point of the sensor 16, is stored in a data memory 22, wherein the first view is assigned to a first door opening angle a1 of the vehicle door 6 relative to the vehicle body 4. Furthermore, a second view of the contour of the vehicle door 4, viewed starting from the mounting point of the sensor 16, is stored in the data memory 22, wherein the second view is assigned to a second door opening angle a2 of the vehicle door 6 relative to the vehicle body 4.

The sensor 16 is designed to determine the door opening angle. In the present case, a plurality of views of the contour of the vehicle door 6 are stored in the data memory 22 and are each assigned to corresponding door opening angles. In this way, it is possible to infer the corresponding door opening angle based on the contour detected in each case.

In addition, an angle encoder 24 is provided to determine the door opening angle.

The sensor 16 is located in the region of an end 26 of the vehicle door 6 facing away from an attachment point 28 of the vehicle door 6.

The sensor 16 is not covered by the vehicle door 6 when the vehicle door 6 is closed, as shown in FIG. 2. In this way, even with the vehicle door 6 closed, the detection of objects 14 in the surroundings of the vehicle 2 is possible at any time.

The sensor 16 is fitted in an upper third of the vehicle 2 when viewed along a height of the vehicle 2 and in the present case is fitted above the vehicle door 6. This enables the very wide field of view 18.

A door drive 30 is assigned to the vehicle door 6. In the present case, the door drive 30 is designed for fully automatic pivoting of the vehicle door 6.

The sensor 16 is designed for three-dimensional detection of the surroundings. In the present case, the sensor 16 is an optical sensor 16.

The sensor 16 is designed to determine the position of a trapping event and a collision event.

The sensor 16 is a non-contact operating sensor 16.

In addition to the sensor 16, a further sensor 32 is provided and assigned to the vehicle door 6, wherein the further sensor 32 is a contact operating sensor 32. The contact operating sensor 32 is an integral component of a door seal 32 of the vehicle 2 and is designed to detect a compression of the door seal 32. To simplify the illustrations, only a section of the door seal 32 is shown, wherein the door seal 32 in a known manner is a rubber tube running circumferentially all around the door opening. The further sensor 32 is therefore used in addition to the sensor 16 for detecting a trapping event between the vehicle door 6 and the vehicle body 4.

A control device 34 is assigned to the anti-trap protection device 10 and the obstacle identification system 12, wherein the control device 34 has the following functions:
a function that may be referred to as door assistance, whereby one or more of the functions listed below are triggered in the event of detection of a trapping event and/or a collision event: emitting a warning signal; limiting an opening path or closing path of the door 6; limiting a closing force of the door 6; initiating countermeasures; blocking or releasing the door 6 in a door angle position, a door opening position or a door closing position. In particular, in the event that a door drive 30 is assigned to the door 6, the control device 34 may actively engage in the positioning or the released actuator or pivot paths of the door 6 using the door assistance function in order to prevent a collision event or a trapping event before it occurs, or to stop it after it is identified.
a function that may be referred to as teach mode and is used to teach a new door geometry. In this mode, the door 6 is moved manually or automatically to different positions of the door opening angle in order to detect the contour of the door 6 associated with a door opening angle. In this way, the system 8 may be adapted to or taught a geometry or a contour of an unknown door 6. This allows the system 8 to be easily used with or adapted to a wide range of different vehicle models.
a function that may be referred to as parking assistance, and enables, in particular, the finding of free parking spaces and the active or fully automatic parking aid, whereby the sensor 16 of the parking assistance function in particular provides data on the position of static or moving objects in the surroundings.
a function that may be referred to as driving assistance and is used, for example, for partially automatic or fully automatic maintenance of a predetermined travel path, whereby the sensor 16 of the driving assistance function in particular provides data on the position of static or moving objects in the surroundings.
a function that may be referred to as access assistance and is used, for example, for the release of access to the passenger compartment or for monitoring the passenger compartment, whereby the sensor 16 in particular provides data for the release and/or monitoring of the door for personal identification, for gesture recognition, for motion detection and for an alarm function.
a function that serves to recognize a gesture or is a hands-on function, whereby, for example, a force pulse measured in the region of the door, together with a position signal of the sensor 16, identifies an opening request of an operator, wherein the force pulse can be assigned to the operator on the basis of the position signal of the sensor and can be distinguished, for example, from a gust of wind or the like. It is thus possible to identify, in particular, whether a hand of the operator was/is arranged on or near the door and the position of the hand can be correlated with a measured force pulse. The function may also include a supporting opening and/or closing of the door, whereby opening and/or closing of the door is carried out autonomously as a result of a pulse introduced into the door by the operator.
a function for warning in case of unsafe terrain, such as holes, debris or similar. If, for example, a deep hole, a chasm or severe unevennesses are identified next to the door, a warning signal, for example, may be emitted and/or the opening of the door may be blocked, even though opening the door in this case would not lead to a collision.

What is claimed is:

1. A system for a vehicle having a vehicle body and a vehicle door held pivotably on the vehicle body, the system comprising:
an anti-trap protection device to detect a trapping event occurring between the vehicle door and the vehicle body; and
an obstacle identification system to detect a collision event occurring between the vehicle door and an object in surroundings of the vehicle;
wherein at least one sensor operates both for detection of the trapping event and for detection of the collision event.

2. The system as claimed in claim 1, further comprising a data memory storing:
a first view of a contour of the vehicle door, viewed starting from a mounting point of the sensor, wherein the first view is assigned to a first door opening angle of the vehicle door relative to the vehicle body; and
a second view of the contour of the door, viewed starting from the mounting point of the sensor, wherein the second view is assigned to a second door opening angle of the door relative to the vehicle body;
wherein the first door opening angle is greater than the second door opening angle.

3. The system as claimed in claim 2, wherein the sensor determines the door opening angle.

4. The system as claimed in claim 1, wherein:
the sensor is located in a region of an end of the vehicle door facing away from an attachment point of the vehicle door;
the vehicle door does not obstruct the sensor when the vehicle door is closed;
the sensor is fitted in an upper third of the vehicle when viewed along a height of the vehicle; and/or
the sensor is fitted in a middle or lower third of the vehicle when viewed along a height of the vehicle.

5. The system as claimed in claim 1, further comprising a door drive assigned to the vehicle door, wherein the door drive is designed for partially or fully automatic pivoting of the vehicle door.

6. The system as claimed in claim 1, wherein:
the sensor is designed for one-dimensional, two-dimensional or three-dimensional identification of the surroundings and/or for measuring distances and/or angles;
the sensor comprises a non-contact operating sensor and operates according to one or more of the following measuring principles: ultrasound, radar, optical;
the sensor can be folded out and/or extended and/or pivoted; and/or
the sensor is designed to determine the position of a trapping event and/or a collision event.

7. The system as claimed in claim 1, further comprising a second sensor assigned to the vehicle door;
wherein the second sensor comprises a contact operating sensor or a near-field operating sensor with a capacitively or resistively operating sensor.

8. The system as claimed in claim 1, further comprising
a control device assigned to the anti-trap protection device and the obstacle identification system, wherein the control device has one or more of the following functions:
door assistance, whereby one or more of the following functions are triggered in the event of detection of a trapping event and/or a collision event: emitting a warning signal; limiting an opening or closing path of the door; limiting a closing force of the door; initiating countermeasures; blocking or releasing the door in a door angle position, a door opening position or a door closing position;
teaching mode for teaching a new door geometry;
parking assistance, whereby the sensor is designed to ascertain parking spaces;
driving assistance, whereby the sensor is designed to ascertain moving and/or static objects in the surroundings of the vehicle, such as, for example, a turn assist system, a parking garage assist system or similar;
access assistance, whereby the sensor is used to enable and/or monitor the door for identification of persons, gesture recognition and motion detection as an alarm function;
recognition of a gesture or hands-on function; and
warning in case of unsafe terrain, such as holes, debris or similar.

9. A vehicle comprising:
a vehicle body;
a vehicle door held pivotably on the vehicle body;
an anti-trap protection device to detect a trapping event occurring between the vehicle door and the vehicle body; and
an obstacle identification system to detect a collision event occurring between the vehicle door and an object in surroundings of the vehicle;
wherein at least one sensor operates both for detection of the trapping event and for detection of the collision event.

10. The vehicle as recited in claim 9, wherein:
two doors of the vehicle are monitored; and
at least one different sensor is assigned to each one of the two doors.

11. The system as claimed in claim 2, further comprising an angle encoder to determine the opening angle.
